(19) United States
(12) Patent Application Publication
(10) Pub. No.: US 2025/0034773 A1
(43) Pub. Date: Jan. 30, 2025

(54) VERTICAL IMPREGNATION BATH FOR PULTRUSION LINES

(71) Applicant: BLUE CUBE IP LLC, St. Louis, MO (US)

(72) Inventors: Lars Friedrich, Stade (DE); Christian Kahrs, Alfstedt (DE)

(21) Appl. No.: 18/710,645

(22) PCT Filed: Nov. 16, 2022
(86) PCT No.: PCT/US2022/079969

§ 371 Date: May 16, 2024

Related U.S. Application Data
(60) Provisional application No. 63/279,965, filed on Nov. 16, 2021.

(51) Int. Cl. D06B 3/02

(52) U.S. Cl. CPC D06B 3/02

(57) ABSTRACT

A vertical impregnation bath for a pultrusion line includes a vertically-oriented reservoir having an inlet adjacent a top end of the reservoir and a terminal area at a bottom end of the reservoir, wherein the inlet is larger than the terminal area of the reservoir and the inlet is above the terminal area of the reservoir, the reservoir further having an outlet adjacent to the terminal area.

### CROSS REFERENCE

This application claims priority to U.S. Provisional Patent Application No. 63/279,965 filed Nov. 16, 2021, the entire disclosure of which is hereby incorporated by reference herein.

### TECHNICAL FIELD

The present disclosure is directed to pultrusion processes for resin impregnation of composite fiber materials and, more particularly, to an improved resin bath for such processes.

### BACKGROUND

Pultrusion is a process used for the production of composite components. Fibers of composite materials are pulled through a resin bath to impregnate the fibers with resin before the fibers are pulled through a die. FIG. 1 schematically illustrates an example of a prior art pultrusion process. The predominant form of pultrusion utilizes an open impregnation bath for impregnation of the fibers. The open impregnation bath is, as the name indicates, a horizontally oriented, open trough containing a quantity of resin through which the fibers are pulled.

Open impregnation baths present a large surface area of resin open to the atmosphere. This introduces significant challenges to the pultrusion process. For example, the high degree of exposure to the atmosphere, which facilitates temperature loss and oxidation, necessitates use of resins with a long potlife. However, this also limits the ability to use high-reactive resins. Further, these open impregnation baths result in uncontrolled exothermic reactions and large potential VOC emissions

In order to allow use of high reactive resins such as polyurethane and some epoxy resins, injection boxes are sometimes used. Injection boxes require a more expensive and complex process and result in a less robust process. An injection box is installed in front of the pultrusion die. The rovings are pulled through the injection box and impregnated in the injection chamber into which resin is continuously fed. The injection box chamber is pressurized to help facilitate good resin impregnation of the rovings. However, if the pressure in the injection box chamber is too great, it can also compress the fibers and make impregnation more difficult. Therefore, pultrusion processes using injection boxes require extremely stringent design and process control, which renders this process more expensive and prone to error.

Therefore, a need exists for an improved impregnation bath to address the issues associated with prior art open baths and injection boxes.

### SUMMARY OF THE DISCLOSURE

An aspect of the present disclosure is to provide a vertical impregnation bath for a pultrusion line that includes a vertically-oriented reservoir having an inlet adjacent a top end of the reservoir and a terminal area at a bottom end of the reservoir, wherein the inlet is larger than the terminal area of the reservoir and the inlet is above the terminal area of the reservoir, the reservoir further having an outlet adjacent to the terminal area.

According to another aspect of the present disclosure, there may be provided at least one guide plate within the reservoir, the guide plate having at least one roving aperture configured to guide a roving into or through the reservoir.

According to another aspect of the present disclosure, there may be provided at least one guiding shaft within the reservoir, the guiding shaft configured to deflect rovings as they move through the reservoir to enhance impregnation of the rovings. According to another aspect of the present disclosure, there may be provided a vertical impregnation bath for a pultrusion line that includes a vertically-oriented reservoir having an inlet adjacent a top end of the reservoir and a terminal area at a bottom end of the reservoir; wherein the inlet is larger than the terminal area of the reservoir and the inlet is higher than the terminal area of the reservoir, the reservoir further having an outlet adjacent to the terminal area, and at least one of an inner guide plate within the reservoir, an upper guide plate adjacent to the inlet, and a guiding shaft within the reservoir.

According to yet another aspect of the present disclosure, there may be provided a method of impregnating rovings with a resin on a pultrusion line that includes the steps of providing a vertical impregnation bath as a component of the pultrusion line, the vertical impregnation path having a vertically-oriented reservoir having an inlet adjacent a top end of the reservoir and a terminal area at a bottom end of the reservoir; wherein the inlet is larger than the terminal area of the reservoir and the inlet is higher than the terminal area of the reservoir, and the reservoir further having an outlet adjacent to the terminal area; and pulling the rovings through the vertical impregnation bath from the inlet to the outlet and through a die adjacent to the outlet.

This aspect is merely illustrative of the innumerable aspects associated with the present disclosure and should not be deemed as limiting in any manner. These and other aspects, features and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the disclosure and wherein similar reference characters indicate the same parts throughout the views.

FIG. 1 is a schematic of a prior art pultrusion process.

FIG. 2 is a schematic of a pultrusion process incorporating a vertical impregnation bath according to an embodiment of the present disclosure.

FIG. 3 is a perspective view of a vertical impregnation bath according to another embodiment of the present disclosure.

FIG. 4 is a top view of the vertical impregnation bath of FIG. 3.

FIG. 5 is a side view of the vertical impregnation bath of FIG. 3.

FIG. 6 is a rear view of the vertical impregnation bath of FIG. 3.

FIG. 7 is a partial section view of the vertical impregnation bath of FIG. 3.

FIG. 8 is a partial section of a vertical impregnation bath incorporating guiding shafts according to another embodiment of the present disclosure.

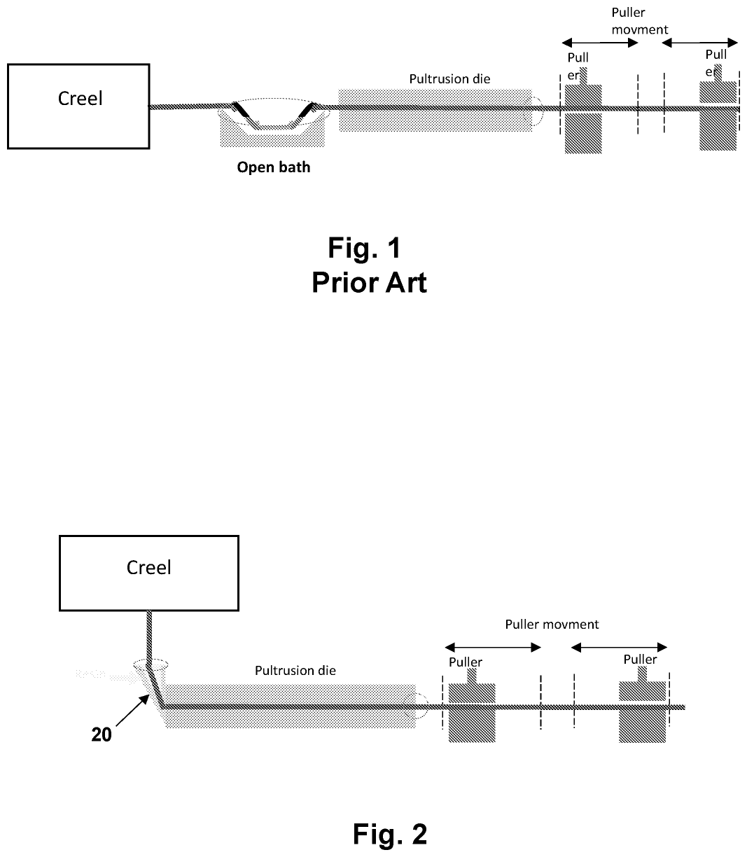

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

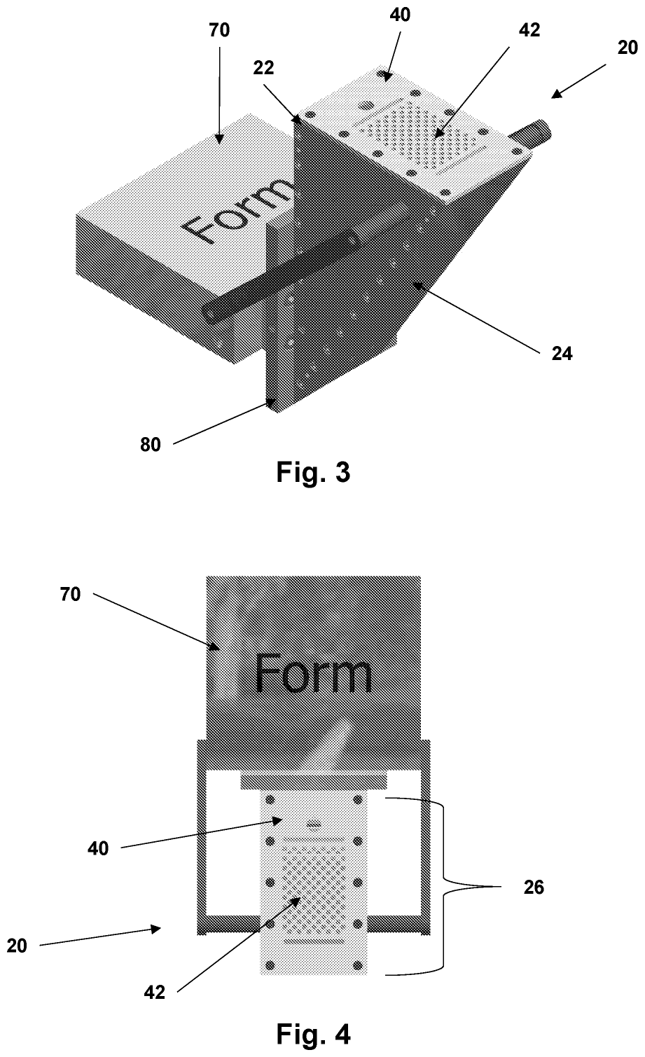

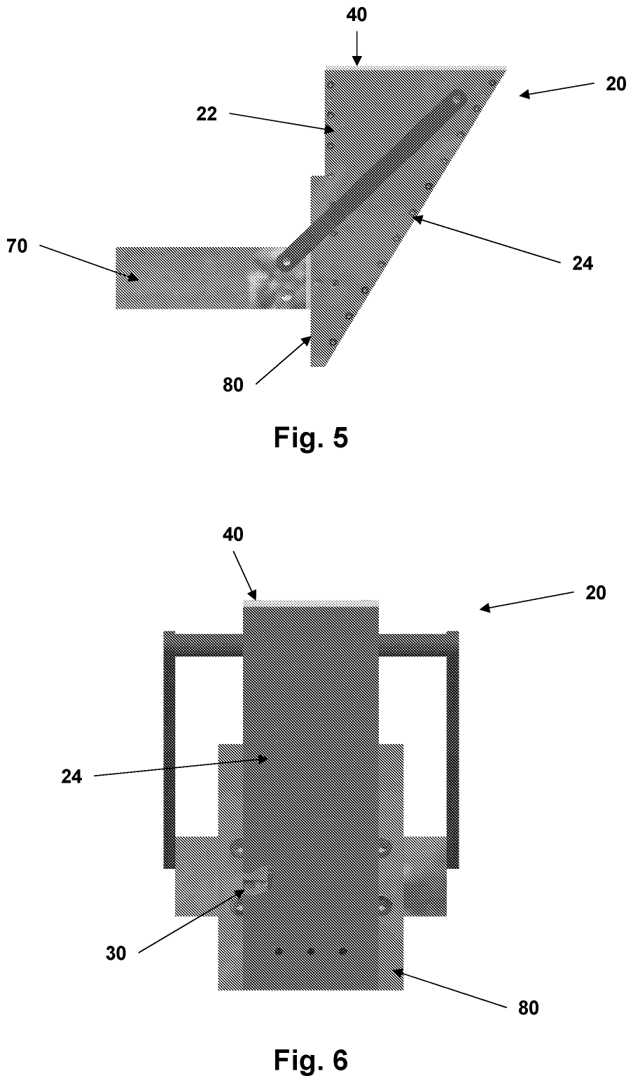

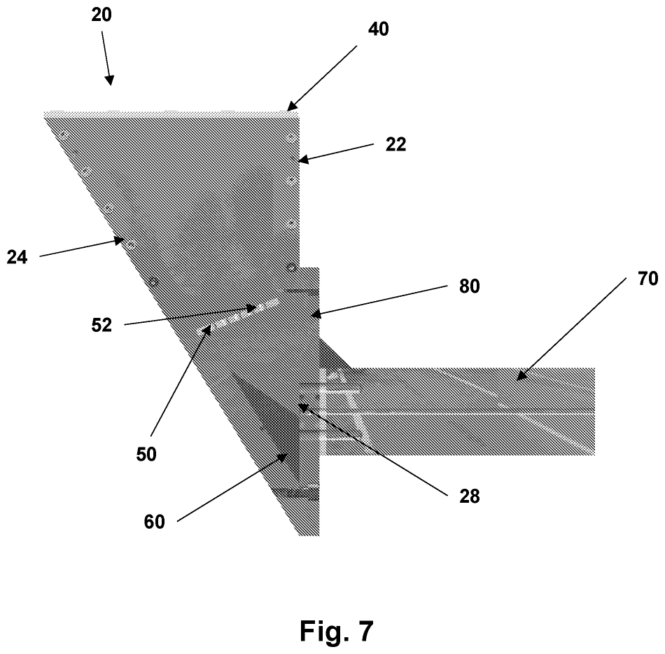

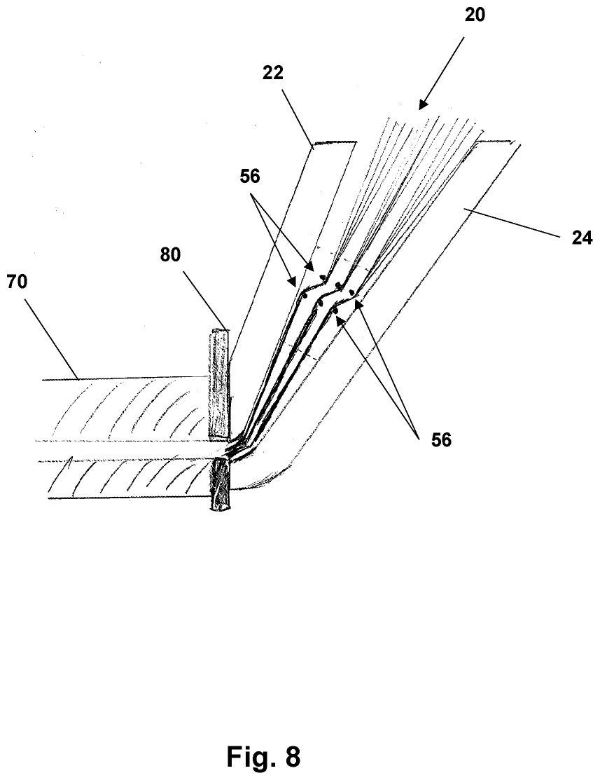

An embodiment of a vertical impregnation bath 20 for various pultrusion processes is illustrated in FIGS. 2-7. In the context of the present disclosure, a “pultrusion” process encompasses processes that include varying degrees of resin curing, for example, mostly or fully cured, partially cured (e.g., pullwinding), and minimal cured or “Wet” profile (e.g., pultruded net shape prepreg). The vertical impregnation bath 20 may be formed generally in a vertically oriented, funnel-type reservoir with a vertical front wall 22 and an angled rear wall 24. In alternate embodiments, such as illustrated in FIG. 8, the front wall 22 may be slightly angled toward the rear wall, maintaining an acute angle between the two walls and creating a narrower funnel shape to the reservoir. An open inlet 26 is located at the top of the vertical impregnation bath 20. The combination of the front wall 22 and angled rear wall 24 produces a continuously narrowing internal geometry that terminates at its narrowest point adjacent to an outlet 28 of the reservoir at which point the now resin-impregnated roving passes from the vertical impregnation bath 20 into an attached forming die 70 for forming. The vertical impregnation bath 20 may include a resin outlet 30 located adjacent to the terminal area of the vertical impregnation bath 20 to allow resin to be drained from the vertical impregnation bath 20. Resin in the vertical impregnation bath 20 is replenished at the reservoir inlet 26 as resin is absorbed by the fibers and the resin level in the vertical impregnation bath 20 drops.

Some embodiments of the vertical impregnation bath 20 allow the rovings or fibers to be pulled through the reservoir at an angle, for example, between approximately 15° and 90°, relative to the horizontal forming die 70 centerline. In another embodiment, the angle may fall between 20° to 45°. Further, the continuous narrowing of the vertical impregnation bath 20 from top to bottom minimizes dead spaces in which resin may begin to cure and harden. While a generally V-shaped cross-sectional shape for the vertical impregnation bath 20 is illustrated, other shapes are also suitable for the vertical impregnation bath 20.

In some embodiments, one or more roving guiding plates may be provided in the resin vertical impregnation bath 20. In the illustrated embodiment, an upper or outer guide plate 40 is provided across the reservoir inlet. This upper guide plate 40 spans the entire reservoir inlet 26, but in other embodiments the upper guide plate may span only a portion of the reservoir inlet 26. The upper guide plate 40 includes one or more apertures 42 passing through the plate to guide fiber rovings into the vertical impregnation bath 20. These apertures 42 may be slots, holes, grids, or other shapes in a variety of sizes to accommodate the appropriate roving for a given application. The apertures 42 may include a mixture of different types of apertures 42. An upper guide plate 32 with a first set of rovings may be replaced with another upper guide plate 32 containing a different set of apertures for a new application. The upper guide plate 40 leaves the vertical impregnation bath 20 open to atmosphere and, therefore, the resin bath is still an open bath. The upper guide plate 32 may be attached to the reservoir inlet 26 or separated by a distance from the inlet 26.

The vertical impregnation bath 20 may also include one or more lower or inner guide plates 40 that are also provided with one or more apertures 42 to accommodate rovings pulled into the vertical impregnation bath 20. The apertures 42 of the lower guide plate 50 may match those of the upper guide plate 40 in use at that time or may have a different arrangement of apertures 42, for example, to begin consolidating rovings prior to passing into the forming die 70. In some embodiments, multiple lower guide plates 50 may have progressively fewer and larger apertures 42 to gradually combine and order rovings as they move through the vertical impregnation bath 20. The apertures 42, 52 of the upper 30 and lower 40 guide allow for controlled passage of individual rovings and smaller fiber bundles, which can improve interaction between the fibers and the resin and, therefore, enhance wetting and resin impregnation of the fibers.

It should be noted that other embodiments of the present disclosure may omit upper and/or lower guide plates without departing from the scope and intent of the present disclosure.

In other embodiments of the present disclosure, for example, as illustrated in FIG. 8, one or more guiding shafts 56 may be provided within the vertical impregnation bath 20. The guiding shaft(s) 56 may be mounted between the side walls of the vertical impregnation bath 20 and oriented transversely to the path of the rovings as they are pulled through the vertical impregnation bath 20. In the illustrated embodiment, a series of transverse guiding shafts 56 are provided in pairs. Each pair of guiding shafts shifts or temporarily deflects a portion of the rovings such the rovings travel in a path at an angle to their primary direction of travel through the vertical impregnation bath 20. This deflection of the rovings as separate groupings around the guide shafts has been found to potential improve resin impregnation of the fibers by, at least in part, spreading the fibers to expose more of their surface area to the resin.

An outlet insert 60 may be provided adjacent to the terminal area at the bottom of the vertical impregnation bath 20. The outlet insert 60 serves to further define the terminal area of the vertical impregnation bath 20 and to help guide the rovings through the reservoir outlet 28 and into the forming die 70. In some embodiments, the outlet insert 60 may also define all or a portion of the shape and size of the reservoir outlet 28. More particularly, the outlet insert 60 may create a reservoir outlet 28 that matches the cross-sectional geometry of the forming die 70 in order to, in essence, pre-form the roving as it passes into the forming die 70.

In other embodiments, the outlet geometry may be incorporated directly in the front wall 22 of the reservoir, and the front 22 and rear 24 walls may be configured to provide for a desired terminal space at the bottom of the vertical impregnation bath 20 without the need for a separate insert 60.

Advantageously, the deepest point of the vertical impregnation bath 20 is located adjacent to the reservoir outlet 28 and the resin outlet 30. Because the vertical impregnation bath 20 is fed with new resin at the reservoir inlet 26 at the top of the vertical impregnation bath 20 as resin level drops and older resin within the lower portion of the vertical impregnation bath 20 is absorbed by the fibers passing through the vertical impregnation bath 20, a self-cleaning effect is produced in which resin does not have an opportunity to reside and age within the vertical impregnation bath 20 for any protracted period of time. Rather, as an example of one possible application, the dwell time of resin within the vertical impregnation bath 20 may typically be in the range of only 2-5 minutes with older resin at the bottom of the vertical impregnation bath 20 being used before the new resin being fed into the bath at the inlet 26.

By accounting for the rate of impregnation of the fibers with resin and adjustment of the supply of new resin into the vertical impregnation bath 20, the dwell time may be configured as desired for a given application. Similarly, the resin level within the vertical impregnation bath 20 may be maintained at a set level or between a set maximum level and a set minimum level. Controlling the resin level within the vertical impregnation bath 20 may assist in ensuring a generally consistent length of exposure of the fibers in the resin as the fibers travel through the vertical impregnation bath 20. This process of refilling the vertical impregnation bath 20 may occur as a batch process or continuously, in which case, for example, the resin outlet 30 may be configured to allow an appropriate flow rate of resin out of the vertical impregnation bath 20—accounting for the rate of impregnation of the resin into the fibers—to maintain the desired resin level.

The vertical impregnation bath 20 may be connected directly to the forming die 70 or with an insulated adapter plate 80. The use of the insulated adapter plate 80 minimizes heat transfer between the forming die 70 and the vertical impregnation bath 20. In alternate embodiments, an active cooling system is utilized in place of an insulated adapter plate.

Embodiments of the present disclosure may provide for a significantly reduced footprint and more efficient configuration for the pultrusion process because the vertical impregnation bath 20 utilizes less space than a prior art open bath and also may replace both the open bath and the spreading unit present in prior art processes. Further, the vertical or substantially vertical orientation of the vertical impregnation bath 20 allows the creel feeding rovings to the vertical impregnation bath 20 to be installed above the pultrusion line. Embodiments of the present disclosure may be readily incorporated into existing pultrusion lines. It should be noted that the scope of the present disclosure encompasses configurations wherein the impregnation bath and/or the direction of travel of rovings through the bath may not be precisely vertical but are at an acute angle to vertical.

A further advantage of embodiments of the vertical impregnation bath described herein is its compatibility with a wide range of resin systems. As noted above, prior art open baths necessitate the use of resins with a long potlife. As also noted above, the dwell time in vertical impregnation baths according to the present disclosure may be significantly reduced. Therefore, resin systems having a shorter potlife may therefore be utilized. For example, the vertical impregnation bath may utilize an epoxy resin in combination with one or more curing agents. Non-limiting examples of resin systems which may be utilized in the vertical impregnation bath include epoxy-anhydride resins, vinyl ester resins, polyurethane resins, or polyester resins.

An additional advantage of the present disclosure includes the ability to more efficiently preheat the fibers prior to entry into the vertical impregnation bath 20 than is possible with prior art open baths. The shorter dwell time of resin within the vertical impregnation bath 20 reduces the possible impact of such pre-heating on the resin. Further, the impregnated fibers do not have a chance to cool between the vertical impregnation bath 20 and the forming die 70 because the configuration of the vertical impregnation bath 20 allows it to be connected directly with the forming die 70.

In addition, the significantly reduced area of the open top surface of the vertical impregnation bath 20 relative to prior art open baths, reduces the amount of resin exposed to atmosphere that may release VOCs and makes it easier to rapidly exhaust any such emissions from the facility.

It should again be noted that these and other embodiments are equally advantageous in various forms of pultrusion, for example, pullwinding and other forms of continuous resin impregnation processes. Therefore, it should be understood the vertical impregnation bath may, for example, be equally adapted for use in connection with a forming die in which the resin is cured or with a short forming die that produces a wetted profile which is then cured in an oven.

The preferred embodiments of the disclosure have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present invention should not be limited by the above-described exemplary embodiment but should be defined only in accordance with the following claims appended hereto and their equivalents.

1. A vertical impregnation bath for a pultrusion line, comprising:
a vertically-oriented reservoir having an inlet adjacent a top end of the reservoir and a terminal area at a bottom end of the reservoir;
wherein the inlet is larger than the terminal area of the reservoir and the inlet is higher than the terminal area of the reservoir, and
the reservoir further having an outlet adjacent to the terminal area.

2. The vertical impregnation bath for pultrusion line as set forth in claim 1, further comprising at least one inner guide plate within the reservoir, the inner guide plate having at least one roving aperture configured to guide a roving into or through the reservoir.

3. The vertical impregnation bath for a pultrusion line as set forth in claim 1, further comprising at least one guiding shaft mounted within the reservoir transversely to a path of rovings being pulled through the vertical impregnation bath, the guiding shaft configured to deflect the rovings along a portion of the path.

4. The vertical impregnation bath for a pultrusion line as set forth in claim 1, wherein the reservoir comprises a vertically oriented, funnel-shaped reservoir with a vertical front wall and an angled rear wall.

5. The vertical impregnation bath for a pultrusion line as set forth in claim 1, wherein the reservoir comprises a vertically oriented, funnel-shaped reservoir.

6. The vertical impregnation bath for a pultrusion line as set forth in claim 1, wherein the reservoir comprises a continuously narrowing internal geometry having a termination point at a low end thereof and wherein the narrowest point of the reservoir is located adjacent to the termination point.

7. The vertical impregnation bath for a pultrusion line as set forth in claim 1, wherein the inlet and outlet are configured such that rovings are pulled through the reservoir at an angle relative to a die adjacent to the outlet.

8. The vertical impregnation bath for a pultrusion line as set forth in claim 7, wherein the angle is between 15° and 90°.

9. The vertical impregnation bath for a pultrusion line as set forth in claim 7, wherein the angle is between 20° to 45°.

10. The vertical impregnation bath for a pultrusion line as set forth in claim 1, further comprising an upper guide plate adjacent to the inlet having at least one roving aperture configured to guide a roving into the reservoir.

11. The vertical impregnation bath for a pultrusion line as set forth in claim 10, further comprising at least one inner guide plate having at least one roving aperture configured to guide a roving into the reservoir.

12. The vertical impregnation bath for a pultrusion line as set forth in claim 11, wherein the at least one roving aperture of the inner guide plate matches the at least one roving aperture of the upper guide plate.

13. The vertical impregnation bath for a pultrusion line as set forth in claim 11, wherein the at least one roving aperture of the inner guide plate differs from the at least one roving aperture of the upper guide plate.

14. The vertical impregnation bath for a pultrusion line as set forth in claim 1, further comprising an outlet insert adjacent to the terminal area at the bottom of the reservoir.

15. A vertical impregnation bath for a pultrusion line, comprising:
a vertically-oriented reservoir having an inlet adjacent a top end of the reservoir and a terminal area at a bottom end of the reservoir;
wherein the inlet is larger than the terminal area of the reservoir and the inlet is higher than the terminal area of the reservoir,
the reservoir further having an outlet adjacent to the terminal area, and
at least one of an inner guide plate within the reservoir, an upper guide plate adjacent to the inlet, and a guiding shaft within the reservoir.

16. A method of impregnating rovings with a resin on a pultrusion line, comprising the steps of:
providing a vertical impregnation bath as a component of the pultrusion line, the vertical impregnation path comprising:
a vertically-oriented reservoir having an inlet adjacent a top end of the reservoir and a terminal area at a bottom end of the reservoir;
wherein the inlet is larger than the terminal area of the reservoir and the inlet is higher than the terminal area of the reservoir, and
the reservoir further having an outlet adjacent to the terminal area; and
pulling the rovings through the vertical impregnation bath from the inlet to the outlet and through a die adjacent to the outlet.

17. The method of impregnating rovings with a resin on a pultrusion line as set forth in claim 16, wherein the step of pulling the rovings through the vertical impregnation bath further comprises pulling the rovings through the reservoir at an angle relative to the die and wherein the angle is between 15° and 90°.

18. The method of impregnating rovings with a resin on a pultrusion line as set forth in claim 16, wherein the step of providing an vertical impregnation bath further comprises providing at least one of an inner guide plate within the reservoir, an upper guide plate adjacent to the inlet, and a guiding shaft within the reservoir.
